(19) United States
(12) Patent Application Publication
(10) Pub. No.: US 2026/0151907 A1
(43) Pub. Date: Jun. 4, 2026

(54) SYSTEMS AND METHODS FOR IMMUTABLE ROBOTIC PROCEDURE OUTCOME PROVENANCE AND REIMBURSEMENT BINDING

(71) Applicant: George William Bickerstaff, III, Greenwich, CT (US)

(72) Inventor: George William Bickerstaff, III, Greenwich, CT (US)

(21) Appl. No.: 19/456,031

(22) Filed: Jan. 22, 2026

(51) Int. Cl. B25J 9/16

(52) U.S. Cl. CPC B25J 9/1661; B25J 9/161

(57) ABSTRACT

Systems and methods for immutable robotic procedure outcome provenance and reimbursement binding are disclosed. A hardware-isolated provenance engine cryptographically binds robotic actions to clinical outcomes and authorization context. Verified provenance is deterministically linked to reimbursement, liability attribution, and regulatory compliance.

### TECHNICAL FIELD

The present invention relates to robotic and computer-assisted medical procedures performed in regulated clinical environments. More particularly, the invention relates to immutable attribution of robotic procedural actions to clinical outcomes and the deterministic binding of such provenance to reimbursement, liability, and regulatory compliance determinations.

### BACKGROUND

Robotic and computer-assisted medical systems increasingly perform or guide procedures whose outcomes directly affect patient safety, clinical effectiveness, and healthcare costs. These systems may generate guidance, execute physical actions, or influence clinical decision-making throughout a procedure.

Existing clinical documentation and billing systems are largely disconnected from the underlying robotic or AI-assisted actions that materially contribute to outcomes. As a result, it is often impossible to deterministically attribute which actions occurred, under what authorization, and how those actions influenced patient outcomes.

Regulators, insurers, and payers increasingly require verifiable evidence that reimbursed procedures were performed within approved protocols, under valid authorization, and in compliance with regulatory and institutional standards. Absent immutable provenance, reimbursement decisions rely on attestations and post hoc documentation that may be incomplete or contested.

Accordingly, there exists a need for a system that cryptographically binds robotic procedural actions to clinical outcomes and deterministically links such provenance to reimbursement eligibility, liability attribution, and regulatory review.

### SUMMARY

The disclosed invention provides systems and methods for immutable robotic procedure outcome provenance and reimbursement binding. A hardware-isolated provenance engine captures and cryptographically binds robotic and guidance actions to procedural context, authorization state, and resulting clinical outcomes.

The system deterministically generates outcome provenance records that associate each material robotic or AI-assisted action with downstream effects, including procedural completion, complications, or deviations. These records are immutable, verifiable, and resistant to tampering.

Reimbursement, liability, and compliance determinations are programmatically bound to verified provenance records, enabling trust-weighted payment models, regulator-verifiable audit trails, and defensible attribution of responsibility.

### DEFINITIONS

Clinical Outcome means a measurable result of a medical procedure, including completion status, complication occurrence, or post-procedural effect.
Outcome Provenance Record means an immutable, cryptographically verifiable record binding procedural actions to outcomes.
Provenance Engine means a hardware-isolated computational component responsible for outcome attribution and record generation.
Reimbursement Binding means deterministic linkage between verified provenance and payment eligibility.
Robotic Action means a physical actuation, guidance output, or system-directed intervention performed by a robotic or computer-assisted system.
Authorization Context means the verified credentials, clearance tokens, and procedural scope applicable at the time of action.
Immutable Ledger means append-only storage resistant to alteration.
Payer System means an insurer, government program, or reimbursement authority.
Regulatory Review Entity means a governmental or institutional oversight body.
Trust-Weighted Payment means reimbursement adjusted based on verified compliance and provenance integrity.

### BRIEF DESCRIPTION OF THE DRAWINGS

FIG. 1—PROCEDURE AND OUTCOME ARCHITECTURE illustrates capture and attribution of robotic actions to clinical outcomes.

FIG. 2—OUTCOME PROVENANCE GENERATION illustrates cryptographic binding of procedural actions to outcome records.

FIG. 3—REIMBURSEMENT BINDING LOGIC illustrates deterministic linkage between provenance and payment eligibility.

FIG. 4—Regulatory and Liability Access illustrates regulator and legal access to immutable provenance.

FIG. 5—LONGITUDINAL OUTCOME ANALYTICS illustrates aggregation and analysis of outcome provenance over time.

### DETAILED DESCRIPTION OF THE DRAWINGS

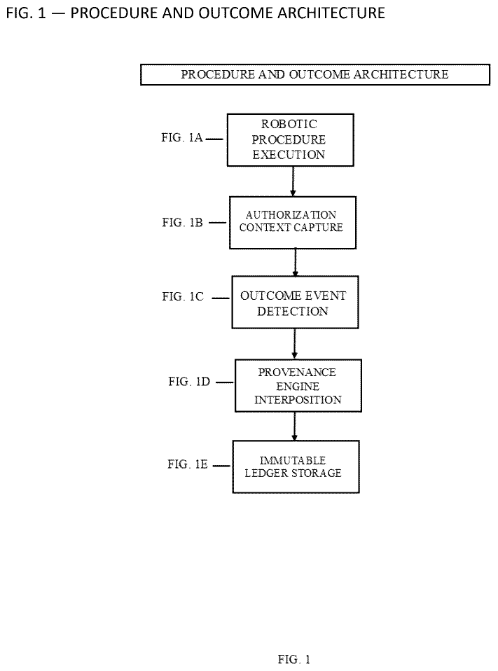

### FIG. 1—Procedure and Outcome Architecture

FIG. 1A—Robotic Procedure Execution illustrates robotic or guidance-assisted actions occurring during a regulated medical procedure. Actions may include physical actuation, navigational guidance, or system-directed interventions. Each action is timestamped and contextualized.

FIG. 1B—Authorization Context Capture illustrates capture of authorization state associated with each action. Credentials, clearance tokens, and scope parameters are bound to the action record. Unauthorized actions are flagged.

FIG. 1C—Outcome Event Detection illustrates detection of clinical outcome events including completion, deviation, or complication. Events may be detected intraoperatively or post-procedure. Outcome signals are correlated to prior actions.

FIG. 1D—Provenance Engine Interposition illustrates a hardware-isolated provenance engine positioned to receive action and outcome data. The engine operates independently of application software. Deterministic attribution is enforced.

FIG. 1E—IMMUTABLE LEDGER STORAGE illustrates storage of outcome provenance records in an append-only ledger. Records are cryptographically signed. Tampering is prevented.

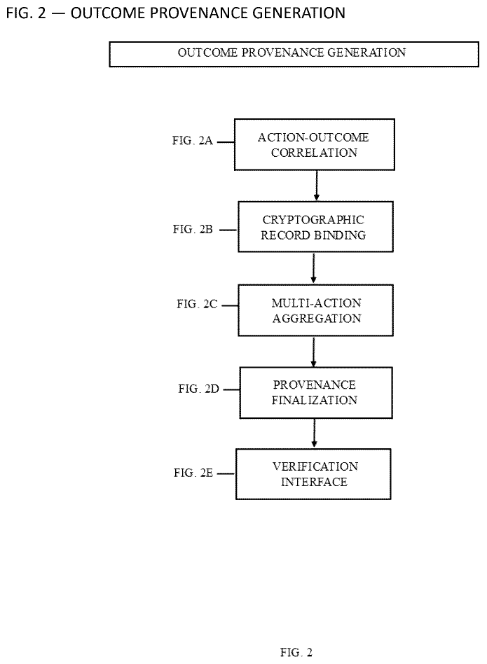

### FIG. 2—Outcome Provenance Generation

FIG. 2A—ACTION-OUTCOME CORRELATION illustrates correlation of robotic actions with subsequent outcome events. Temporal and contextual relationships are evaluated. Attribution is deterministic.

FIG. 2B—CRYPTOGRAPHIC RECORD BINDING illustrates cryptographic binding of actions, authorization context, and outcomes. Records cannot be altered without detection. Integrity is preserved.

FIG. 2C—MULTI-ACTION AGGREGATION illustrates aggregation of multiple actions contributing to a single outcome. Contribution weights may be assigned. Complex procedures are supported.

FIG. 2D—PROVENANCE FINALIZATION illustrates finalization of outcome provenance records. Records are sealed upon procedure completion. Post hoc modification is prevented.

FIG. 2E—VERIFICATION INTERFACE illustrates independent verification of provenance records. Third parties may validate authenticity. Verification does not alter records.

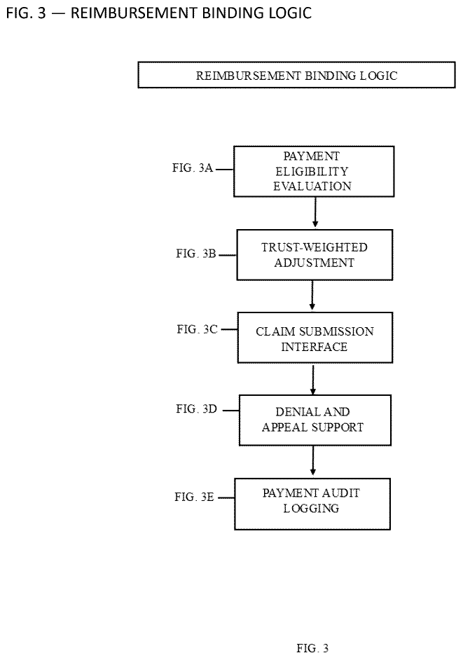

### FIG. 3—Reimbursement Binding Logic

FIG. 3A—PAYMENT ELIGIBILITY EVALUATION illustrates evaluation of outcome provenance against reimbursement rules. Compliance and authorization are deterministically checked. Eligibility is computed.

FIG. 3B—TRUST-WEIGHTED ADJUSTMENT illustrates adjustment of reimbursement based on provenance integrity and compliance. Higher trust yields favorable reimbursement. Deviations reduce eligibility.

FIG. 3C—CLAIM SUBMISSION INTERFACE illustrates automated submission of provenance-backed reimbursement claims. Manual attestation is minimized. Disputes are reduced.

FIG. 3D—DENIAL AND APPEAL SUPPORT illustrates use of provenance records to support denial review or appeal. Evidence is precise and verifiable. Resolution is expedited.

FIG. 3E—PAYMENT AUDIT LOGGING illustrates immutable logging of reimbursement decisions. Auditability is preserved. Transparency is increased.

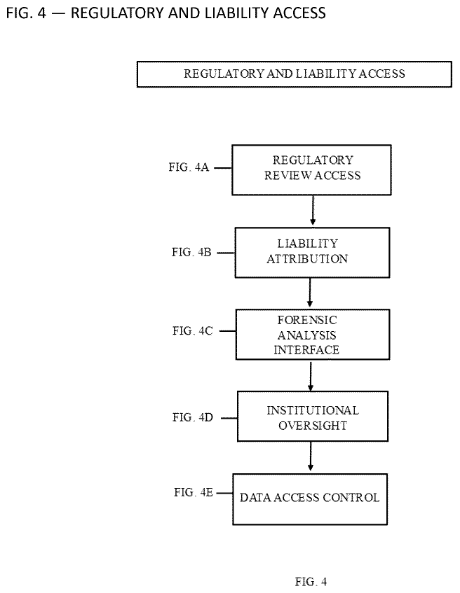

### FIG. 4—Regulatory and Liability Access

FIG. 4A—REGULATORY REVIEW ACCESS illustrates regulator access to outcome provenance. Compliance verification occurs without patient-identifiable data. Oversight is supported.

FIG. 4B—LIABILITY ATTRIBUTION illustrates attribution of responsibility across human, robotic, and system components. Provenance clarifies causality. Legal ambiguity is reduced.

FIG. 4C—FORENSIC ANALYSIS INTERFACE illustrates forensic reconstruction of procedures using provenance records. Timelines are precise. Evidence integrity is preserved.

FIG. 4D—INSTITUTIONAL OVERSIGHT illustrates hospital or institutional review of outcomes. Quality improvement is supported. Governance policies are enforced.

FIG. 4E—DATA ACCESS CONTROL illustrates access control over provenance records. Permissions are enforced. Privacy is preserved.

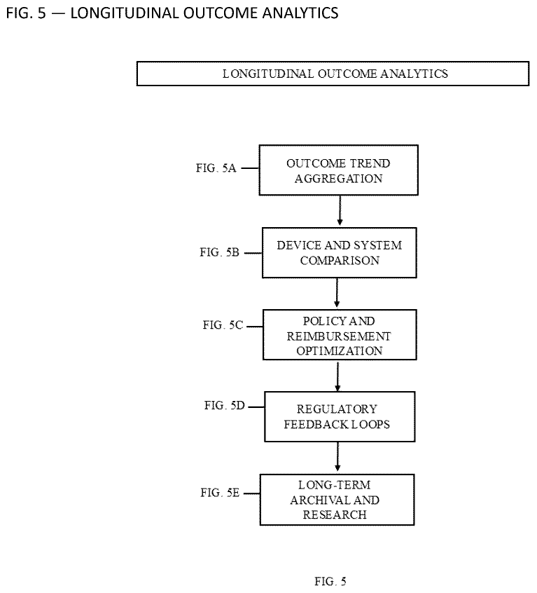

### FIG. 5—Longitudinal Outcome Analytics

FIG. 5A—OUTCOME TREND AGGREGATION illustrates aggregation of outcome provenance across procedures. Trends are identified. System performance is evaluated.

FIG. 5B—DEVICE AND SYSTEM COMPARISON illustrates comparison of robotic systems based on verified outcomes. Objective benchmarking is enabled. Marketing claims are validated.

FIG. 5C—POLICY AND REIMBURSEMENT OPTIMIZATION illustrates use of aggregated provenance to refine reimbursement models. Payment policies evolve based on evidence. Waste is reduced.

FIG. 5D—REGULATORY FEEDBACK LOOPS illustrates feedback from outcomes to regulatory standards. Evidence informs rulemaking. Safety improves.

FIG. 5E—LONG-TERM ARCHIVAL AND RESEARCH illustrates archival of provenance for research and longitudinal studies. Data authenticity persists. Scientific integrity is maintained.

### EXAMPLES

### Example 1—Robotic Surgical Reimbursement

A robotic-assisted procedure is completed without deviation under valid authorization. Outcome provenance confirms compliance and favorable outcome. Full reimbursement is automatically approved.

### Example 2—Complication Attribution

A post-procedural complication occurs. Provenance records identify contributing robotic guidance and authorization context. Liability attribution is clarified and reimbursement adjusted.

1. A system for binding robotic procedural actions to clinical outcomes, comprising:
a hardware-isolated provenance engine configured to capture robotic actions and authorization context;
an immutable ledger storing cryptographically bound outcome provenance records; and
a reimbursement binding module deterministically linking verified provenance to payment eligibility.

2. A computer-implemented method comprising:
capturing robotic or guidance-assisted procedural actions;
correlating the actions to clinical outcomes;
generating immutable outcome provenance records; and
binding reimbursement eligibility to verified provenance.

3. A non-transitory computer-readable medium storing instructions that, when executed by a hardware-isolated provenance engine, cause the system to perform the method of claim 2.

4. The system of claim 1, wherein provenance records are cryptographically signed.

5. The system of claim 1, wherein reimbursement is trust-weighted based on compliance.

6. The system of claim 1, further comprising regulatory access controls.

7. The method of claim 2, wherein outcomes include complications.

8. The method of claim 2, wherein multiple actions are aggregated into a single outcome record.

9. The system of claim 1, wherein liability attribution is supported by provenance.

10. The non-transitory computer-readable medium of claim 3, further storing instructions for audit and appeal support.
